(19) United States
(12) Patent Application Publication
(10) Pub. No.: US 2007/0233326 A1
(43) Pub. Date: Oct. 4, 2007

(54) Engine self-tuning methods and systems

(75) Inventor: Amit Jayachandran, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/393,956

(22) Filed: Mar. 31, 2006

(51) Int. Cl. G05D 1/00

(52) U.S. Cl. 701/1

(57) ABSTRACT

A method is provided for controlling an engine. The method may include generating a first neural network model indicative of interrelationships between a plurality of sensing parameters and a plurality of engine operational parameters. The method may also include generating a second neural network model indicative of interrelationships between the plurality of engine operational parameters and at least a desired emission level. The method may also include providing, by the first neural network model, a first set of values of the plurality of engine operational parameters to the second neural network model and to the engine. Further, the method may include determining, by the second neural network model, values of adjusting parameters of the first neural network model based on the values of the plurality of engine operational parameters, the desired emission level, and an actual emission level of the engine.

### TECHNICAL FIELD

This disclosure relates generally to engine control systems and, more particularly, to artificially intelligent engine control systems and methods.

### BACKGROUND

Modern engines are becoming increasingly complex and are often subject to stringent requirements such as fuel efficiency requirements, power output requirements, and/or emission control requirements, etc. Sophisticated engine control systems are provided for controlling engines with high precision to meet these requirements. For example, U.S. Patent Application Publication No. 2003/0187567 to Sulatisky et al. on Oct. 2, 2003, discloses a neural network control system providing variable fuel injection pulses based on different fuels used by an dual-fuel engine, where a neural network model dynamically adjusts the pulse widths based on air temperature, engine speed, and exhaust gas oxygen (EGO) content with reference to a desired air-to-fuel ratio.

However, because most engines, after being manufactured and assembled, may also vary from one to another, individual calibration may need to be performed for the engine control system to set desired engine operational parameters in order to meet the these stringent requirements. Further, because engines may often wear over time, calibration maps may be needed for different stages of an engine's life to manually provide desired engine operational parameters and to recalibrate individual engines for wear effects. Conventional techniques often fail to address such calibration issues. Manufacturing costs and/or maintenance costs may rise significantly due to such calibrations and recalibrations over the life of an engine.

Methods and systems consistent with certain features of the disclosed systems are directed to solving one or more of the problems set forth above.

### SUMMARY OF THE INVENTION

One aspect of the present disclosure includes a method for controlling an engine. The method may include generating a first neural network model indicative of interrelationships between a plurality of sensing parameters and a plurality of engine operational parameters. The method may also include generating a second neural network model indicative of interrelationships between the plurality of engine operational parameters and at least a desired emission level. The method may also include providing, by the first neural network model, a first set of values of the plurality of engine operational parameters to the second neural network model and to the engine. Further, the method may include determining, by the second neural network model, values of adjusting parameters of the first neural network model based on the values of the plurality of engine operational parameters, the desired emission level, and an actual emission level of the engine.

Another aspect of the present disclosure includes a engine control system for controlling an engine. The engine control system may include plural physical sensors configured to provide a plurality of sensing parameters and a processor. The processor may be configured to generate a first neural network model indicative of interrelationships between the plurality of sensing parameters and a plurality of engine operational parameters and to generate a second neural network model indicative of interrelationships between the plurality of engine operational parameters and at least a desired emission level. The processor may also be configured to provide, via the first neural network model, a first set of values of the plurality of engine operational parameters to the second neural network model and to the engine. Further, the processor may be configured to determine, via the second neural network model, values of adjusting parameters of the first neural network model based on the values of the plurality of engine operational parameters, the desired emission level, and an actual emission level of the engine.

Another aspect of the present disclosure includes a vehicle. The vehicle may include an engine which provides power to the vehicle and produces NOx emission at an actual NOx emission level and a control system configured to control the engine. The control system may include a processor and the processor may be configured to generate a first neural network model indicative of interrelationships between a plurality of sensing parameters and a plurality of engine operational parameters and to generate a second neural network model indicative of interrelationships between the plurality of engine operational parameters and at least a desired NOx emission level. The processor may also be configured to provide, via the first neural network model, a first set of values of the plurality of engine operational parameters to the second neural network model and to the engine. Further, the processor may be configured to determine, via the second neural network model, values of adjusting parameters of the first neural network model based on the values of the plurality of engine operational parameters, the desired NOx emission level, and the actual NOx emission level of the engine.

### BRIEF DESCRIPTION OF THE DRAWINGS

FIG. 1 illustrates an exemplary vehicle in which features and principles consistent with certain disclosed embodiments may be incorporated;

FIG. 2 illustrates a block diagram of an exemplary engine control module (ECM) consistent with certain disclosed embodiments;

FIG. 3 illustrates a logical block diagram of an exemplary operational environment of an engine system consistent with certain disclosed embodiments; and

FIG. 4 illustrates a flowchart diagram of an exemplary operational process consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

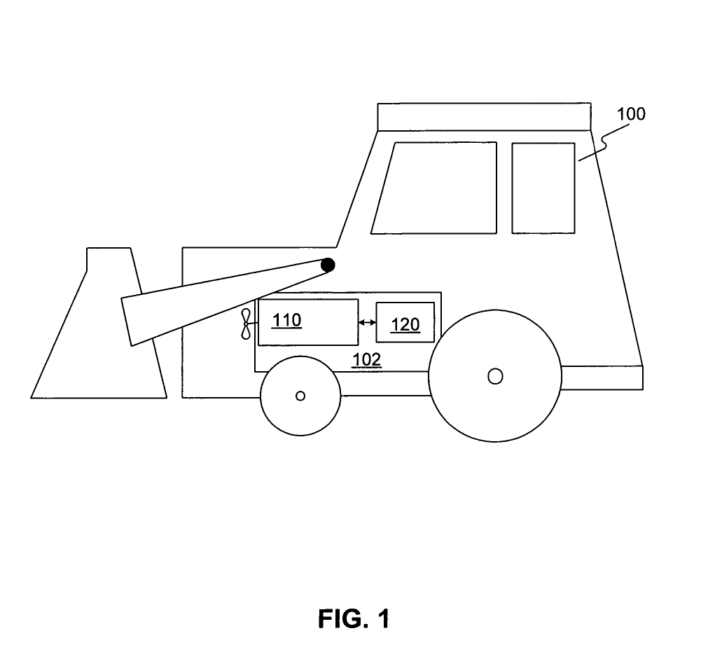

FIG. 1 illustrates an exemplary vehicle 100 in which features and principles consistent with certain disclosed embodiments may be incorporated. Vehicle 100 may include any type of fixed or mobile machine that performs some type of operation associated with a particular industry, such as mining, construction, farming, transportation, etc. and operates between or within work environments (e.g., construction site, mine site, power plants and generators, on-highway applications, etc.). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment. Vehicle 100 may also include any type of commercial vehicles such as cars, vans, and other vehicles.

As shown in FIG. 1, vehicle 100 may include an engine system 102. Engine system 102 may include an engine 1 10 and an engine control module (ECM) 120. Other devices or components, however, may also be included. Engine 110 may include any appropriate type of engine or power source that generates power for vehicle 100, such as an internal combustion engine.

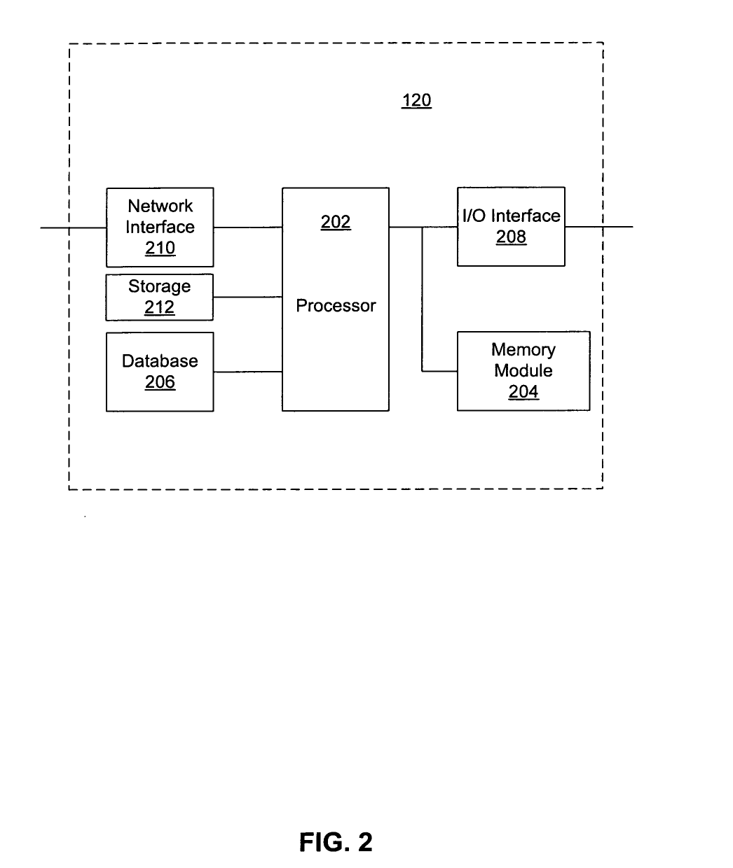

ECM 120 may include any appropriate type of engine control system configured to perform engine control functions such that engine 110 may operate properly. ECM 120 may also control other systems of vehicle 100, such as transmission systems, and/or hydraulics systems, etc. FIG. 2 shows an exemplary functional block diagram of ECM 120.

As shown in FIG. 2, ECM 120 may include a processor 202, a memory module 204, a database 206, an I/O interface 208, a network interface 210, and a storage 212. Other components or devices, however, may also be included in ECM 120.

Processor 202 may include any appropriate type of general purpose microprocessor, digital signal processor, or microcontroller. Memory module 204 may include one or more memory devices including, but not limited to, a ROM, a flash memory, a dynamic RAM, and/or a static RAM. Memory module 204 may be configured to store information used by processor 202. Database 206 may include any type of appropriate database containing information on engine parameters, operation conditions, mathematical models, and/or any other control information.

Further, I/O interface 208 may include any appropriate type of device or devices provided to couple processor 202 to various physical sensors or other components (not shown) within engine system 102 or within vehicle 100. Information may be exchanged between the physical sensors or other components and processor 202. Users of vehicle 100 may also exchange information with processor 202 through I/O interface 208. For example, the users may input data to processor 202, and processor 202 may output data to the users, such as warning or status messages.

Network interface 210 may include any appropriate type of network device capable of communicating with other computer systems based on one or more communication protocols. Network interface 210 may communicate with other computer systems within vehicle 100 or outside vehicle 100 via certain communication media such as control area network (CAN), local area network (LAN), and/or wireless communication networks.

Storage 212 may include any appropriate type of mass storage provided to store any type of information that processor 202 may need to operate. For example, storage 212 may include one or more hard disk devices, optical disk devices, or other storage devices to provide storage space.

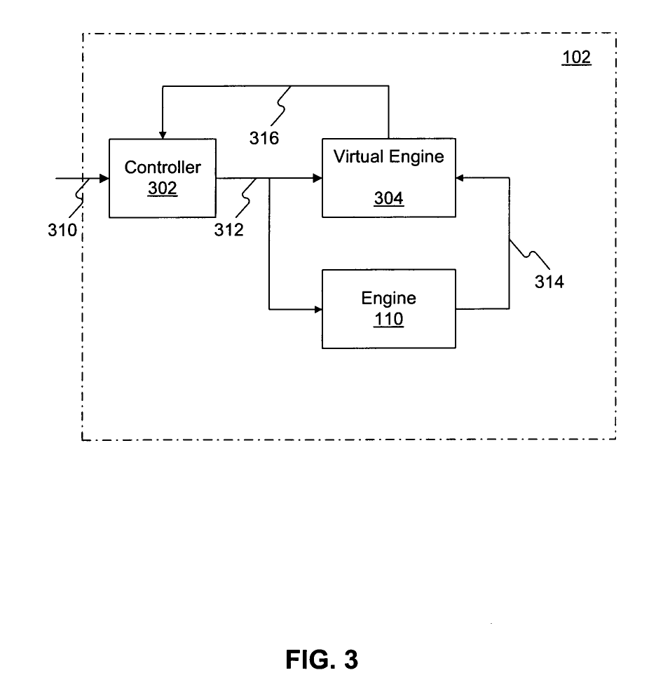

In operations, computer software instructions may be stored in or loaded to ECM 120. ECM 120 may execute the computer software instructions to perform various control functions and processes to control engine 110 and to automatically adjust engine operational parameters, such as fuel injection timing and fuel injection pressure, etc. FIG. 3 shows an exemplary operational environment of engine system 102.

As shown in FIG. 3, ECM 120 may create or include an controller 302 and a virtual engine 304 to control engine 110 within engine system 102. Controller 302 may be provided with inputs 310 and may generate engine operational parameters 312. Engine operational parameters 312 may include any appropriate parameters provided to engine 110 by ECM 120 to control certain aspects of engine operations. For example, engine operational parameters 312 may include fuel injection timing and fuel injection pressure, etc., to control power out and/or emissions of engine 110.

Engine operational parameters 312 may be provided to engine 110 during operations of engine system 102. Engine 110 may operate based on the provided engine operational parameters 312 and also may provide a measurement of actual emission levels, such as an actual NOx emission level 314. On the other hand, virtual engine 304 may also be provided with engine operational parameters 312 and may provide adjusting parameters 316 back to controller 302.

Controller 302 and virtual engine 304 may generate desired engine operational parameters 312 to adjust manufacturing variations among engines and/or wear effects of a particular engine. With the desired engine operational parameters 312, emission levels of engine 110 may be kept below a predetermined threshold during the life of engine 110. The emission levels of engine 110 may include measurable levels of emissions, such as levels of Nitrogen Oxides (NOx), Sulfur Dioxide (SO₂), Carbon Monoxide (CO), total reduced Sulfur (TRS), etc. In particular, NOx emission level may be important to normal operation of engine 110 and/or to meet certain environmental requirements.

Controller 302 may include an artificial intelligence model to provide engine operational parameters 312 based on inputs 310. For example, controller 302 may include any appropriate type of mathematical or physical model indicating interrelationships between inputs 310 and engine operational parameters 312. More particularly, controller 302 may include a neural network based mathematical model that is trained to capture interrelationships between inputs 310 and engine operational parameters 312. Other types of mathematic models, such as fuzzy logic models, linear system models, and/or non-linear system models, etc., may also be used.

Inputs 310 may include any appropriate information that is provided to ECM 120 and more specifically, to controller 302, by other control systems and/or physical sensors. For example, inputs 310 may include turbocharger efficiency, aftercooler characteristics, temperature values (e.g., intake manifold temperature), pressure values (e.g., intake manifold pressure), ambient conditions (e.g., ambient humidity), fuel rates, and engine speeds, etc. Further, inputs 310 may also include certain calibration data, such as desired NOx level, etc. Because most of inputs 310 may be provided by various physical sensors, inputs 310 may also be referred to as sensing parameters.

On the other hand, virtual engine 304 may include any appropriate type of mathematical or physical model that reflects interrelationships between engine operational parameters 312 and certain engine output parameters, such as power output and emission levels, etc., and other related parameters. The mathematical or physical model may be created based on a particular engine or a standard engine (e.g., a desired engine). For example, virtual engine 304 may include a neural network model reflecting interrelationships between engine operational parameters 312 and a desired NOx level.

The desired NOx level may refer to the NOx emission level of a desired engine and/or the expected or predicted NOx emission level based on a particular engine or engines. The desired NOx level may be determined based on factors such as engine type, age, operational stages (e.g., certain degrees of wear effect, etc.) and operational conditions (e.g., downhill, uphill, braking, etc.), etc., and may have a series values corresponding to these factors. Virtual engine 304 may generate the desired NOx level based on the model, or, virtual engine 304 may include a virtual NOx sensor (not shown) to provide the desired NOx level. In addition, virtual engine 304 may obtain the desired NOx level from other devices or subsystems (not shown) within vehicle 100.

Virtual engine 304 may also generate adjusting parameters 316 for controller 302. Adjusting parameters 316 may include any information that may be provided to controller 302 for adjusting and/or re-training the artificial intelligence model of controller 302 to improve accuracy of controller 302. For example, adjusting parameters 316 may be provided to controller 302 to adjust controller 302 to generate improved engine operational parameters 312 to keep actual NOx level 314 at a desired level. Also for example, adjustment parameters 316 may include a back-propagation error of the neural network model of controller 302 to be used to adjust weights of neural nodes of the neural network model of controller 302. After the weights of the neural network model are adjusted, controller 302 may generate more accurate or desired engine operational parameters 312 based on inputs 310. On the other hand, adjusting parameters 316 may also include any input parameters provided to controller 302 by virtual engine 304, such as the desired NOx level.

The mathematical or physical model of virtual engine 304 may also include a neural network based mathematical model that is trained to capture interrelationships between engine operational parameters 312, the engine output parameters (e.g., NOx emission level, etc.), and/or other related parameters (e.g., adjusting parameters 316, etc.). Other types of mathematic models, however, may also be used.

The neural network model or models used in virtual engine 304 and/or controller 302 may include any appropriate types of neural networks. For example, the neural network models may include back propagation models, feed forward models, inverse neural networks, cascaded neural networks, and/or hybrid neural networks, etc. Particular types or structures of the neural network models may depend on particular applications. The neural network models may be trained and validated through off-line computer systems as well as on ECM 120.

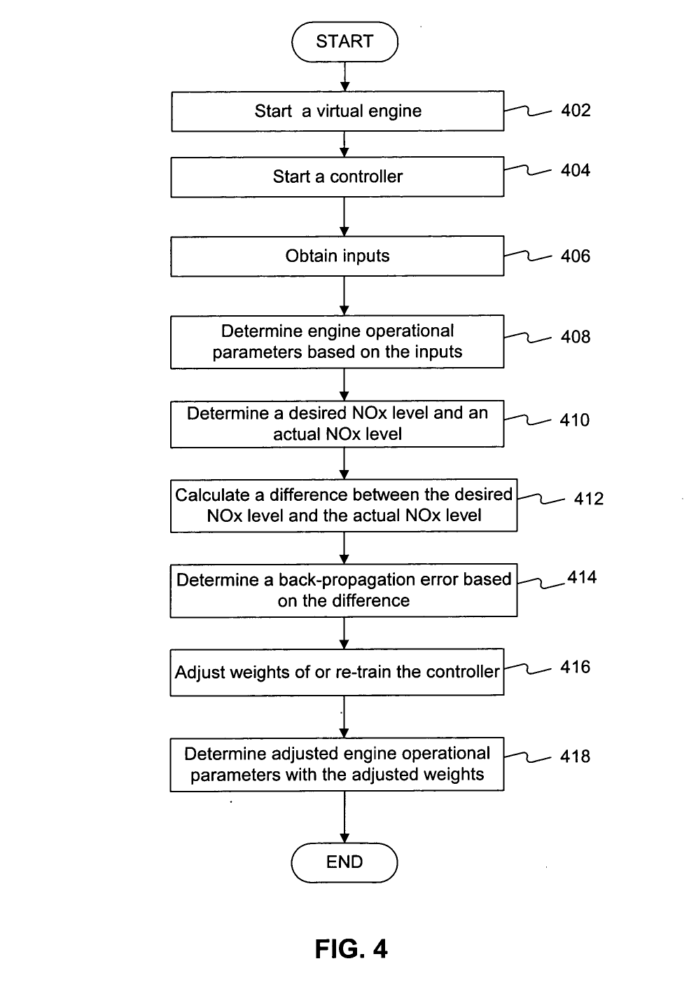

As explained above, during operations, ECM 120 may create or activate controller 302 and virtual engine 304 to control operations of engine 110 such that emission levels (e.g., actual NOx level 314) may be kept below a predetermined threshold or at a desired level. FIG. 4 shows an exemplary operational process performed by ECM 120 or more specifically, by processor 202 of ECM 120.

As shown in FIG. 4, at the beginning of the operational process, processor 202 may start virtual engine 304 by generating an engine neural network model (step 402). The engine neural network model may be previously trained and validated and may be loaded into memory module 204 from storage 212 or database 206 in the runtime, or may be trained and validated in real-time by processor 202. The engine neural network model may be established based on data records previously collected.

The data records used to establish the engine neural network model may be collected from any appropriate data source. For example, the data records experiments may be collected from tests designed for collecting such data or may be collected from a standard or desired engine, that is, an engine with desired engine output parameters such as desired NOx levels.

The data records may also be collected during different operational stages and/or operational conditions in the life of an engine to reflect desired NOx levels during the different stages after various degrees of wear effects caused by continuously operations of the engine and/or under different operational conditions. In addition, the data records may also be generated artificially by other related processes, such as other emission modeling or analysis processes. The data records may be used in various stages of establishing the neural network model.

After being established based on the data records, the engine neural network model may reflect interrelationships among engine operational parameters 310, the desired NOx level, the operational stages, actual NOx level 314, and/or adjusting parameters 316. That is, the engine neural network model may provide values of adjusting parameters 316 when provided with engine operational parameter 310, actual NOx level 314, and/or the desired NOx level of different operational stages of engine 110.

Processor 202 may also start controller 302 by generating a control neural network model (step 404). The control neural network model may also be previously established and may be loaded into memory module 204 from storage 212 or database 206 in the runtime, or may be trained and validated in real-time by processor 202, based on data records collected for the purpose of establishing controller 302. The data records may includes various input parameters or sensing parameters, such as compression ratios, turbocharger efficiency, after cooler characteristics, temperature values (e.g., intake manifold temperature), pressure values (e.g., intake manifold pressure), ambient conditions (e.g., ambient humidity), fuel rates, engine age, engine physical parameters, and engine speeds, etc., and various output parameters such as power output, fuel injection timing, pressure, etc. Based on the data records, the control neural network model may be trained and validated to reflect interrelationships between inputs 310 and engine operational parameters 312 (e.g., fuel injection timing and pressure, etc.) during the life of engine 110 at various stages with different wear effects.

After the control neural network model is trained and validated, the control neural network model may be used to generate values of engine operational parameters 312 (e.g., fuel injection timing and pressure, etc.) when provided with values of inputs 310. However, because an individual engine may vary from the desired engine used to train and validate the control neural network model, or the individual engine may operate under different operational stages or conditions from that of the desired engine, the values of engine operational parameters 312 may be less desired. Certain adjustments may need to be made to correct values of engine operational parameters 312 provided to engine 110.

The control neural network model may also be automatically adjusted through a back-propagation process to improve accuracy of the control neural network model (i.e., to minimize the back-propagation error). In the back-propagation process, network weights of the control neural network model may be adjusted to minimize the back-propagation error. The back-propagation error may refer to differences between network outputs (e.g., engine operational parameters 312) and the corresponding desired target values of the network outputs. Error gradients may be computed by moving backwards from output nodes to input nodes of the control neural network model and the weights of network nodes may be adjusted to minimize the back-propagation error. The back-propagation process may be used in training of the control neural network model and/or re-training of the control neural network model in real-time during operations. In such circumstances, the control neural network model may include an inverse neural network model, which may be a partial inverse model or full inverse model.

Further, processor 202 may obtain inputs 310 from various physical sensors and/or other components of engine system 102 (step 406). After inputs 310 are obtained, processor 202 may, via controller 302, determined engine operational parameters 312 based upon inputs 310 (step 408). Controller 302 or, more specifically, the control neural network model included in controller 302, may derive values of engine operational parameters 312 based on the values of inputs 310 and the interrelationships established between inputs 310 and engine operational parameters 312. The derived engine operational parameters 312 may be provided to both engine 110 and virtual engine 304.

Engine 110 may operate based on engine operational parameters 312 and may also provide actual NOx level 314. Engine 110 may provide actual NOx level 314 by having a NOx sensor that measures the actual NOx emission level. On the other hand, processor 202 may, via virtual engine 304, determine a desired NOx level of engine 110 and actual NOx level 314 (step 410). As explained above, virtual engine 304 may include an engine neural network model to determine the desired NOx level or may include a separate virtual NOx sensor to determine the desired NOx level. Processor 202 may provide the desired NOx level to controller 302, which may determine a set of values of engine operational parameters 312 based on the provided desired NOx level. Further, the set of values of engine operational parameters 312 corresponding to the provided desired NOx level may be provided to engine 110. Engine 110 may generate a new value of actual NOx level 314 based on the set of values of engine operational parameters 312 via physical sensors.

Once provided with both actual NOx level 314 and the desired NOx level, processor 202 may, via virtual engine 304, calculate a difference between the determined values of the desired NOx level and actual NOx level 314 (step 412). Processor 202 may also, via virtual engine 304, determine a back-propagation error (i.e., adjusting parameters 316) for the control neural network model (step 414). Processor 202 may determine the back-propagation error based on the engine neural network model using values of engine operational parameters 312 and the difference between the desired NOx level and actual NOx level 314. For example, processor 202 may determine a direction and/or an amount of changes need to be made regarding engine operational parameters 312 based on the difference between the desired NOx level and actual NOx level 314, and may further determine the back-propagation error from the direction and/or the amount of changes in engine operational parameters 312.

When calculating the difference between the desired NOx level and actual NOx level 314, processor 202 may also determine whether the difference is within a predetermined range. If the difference is out of the predetermined range, processor 202 may further determine that the actual NOx level is not reliable and may send out an alarm message to warn users of vehicle 100 about a potential failure of the physical NOx sensor that provides the actual NOx level. Further, processor 202 may also keep the current operational status to continue operate engine 110. For example, processor 202 or virtual engine 304 may set the back-propagation error to zero to stop re-training controller 302 due to the failure of the physical NOx sensor.

Further, after a valid back-propagation error is generated by virtual engine 304, processor 202 may, via controller 302, adjust weights of the control neural network model (e.g., weights of neural nodes of the control neural network model) based on the back-propagation error (step 416). That is, the control neural network model may be re-trained to minimize the difference between the desired NOx level and actual NOx level 314 based on the propagation error.

After re-training the control neural network model, processor 202 may, via controller 302, determine adjusted engine operational parameters 312 based upon inputs 310 (step 418). The adjusted engine operational parameters 312 may reflect certain engine-to-engine variability, initial calibration errors, and/or wear effects during different operational stages of engine 110. Processor 202 may continue the exemplary operational process in step 41 0 during operations of ECM 120 and/or engine system 102 such that engine system 102 may be continuously and automatically self-tuned to operate under desired operational parameters and to produce NOx emissions at a desired level.

### INDUSTRIAL APPLICABILITY

The disclosed systems and methods may provide efficient and accurate self-learning artificially intelligent control systems to adjust or correct errors arising from engine-to-engine variations, engine wear effects, and/or varying operational conditions. Certain NOx sensor failures may also be detected by the disclosed systems and methods. Further, the disclosed systems and methods may reduce manufacturing and maintenance costs by removing the need for calibrations maps for different stages of a particular engine during the life of the engine and/or removing the need for implementing certain PID (proportional-integral-derivative) controllers in engine control systems.

The disclosed systems and methods may also provide flexible implementations of control functions of engine control systems in computer software programs. Further, the disclosed systems and methods may also be used to control other output parameters of engines, such as other forms of emissions or other related parameters.

Researchers and developers of engine technologies may use the disclosed systems and methods to design more efficient engines. Manufacturers of engines, power equipment, and vehicles may also use the disclosed systems and methods to improve the engines to meet more stringent environmental requirements, and to reduce cost of manufacturing and maintenance. In addition, the disclosed systems and methods may also be used in other fields of control systems as well, by applying the disclosed control system principles and examples.

Other embodiments, features, aspects, and principles of the disclosed exemplary systems will be apparent to those skilled in the art and may be implemented in various environments and systems.

1. A method for controlling an engine, comprising:
generating a first neural network model indicative of interrelationships between a plurality of sensing parameters and a plurality of engine operational parameters;
generating a second neural network model indicative of interrelationships between the plurality of engine operational parameters and at least a desired emission level;
providing, by the first neural network model, a first set of values of the plurality of engine operational parameters to the second neural network model and to the engine;
determining, by the second neural network model, values of adjusting parameters of the first neural network model based on the values of the plurality of engine operational parameters, the desired emission level, and an actual emission level of the engine; and
providing a second set of values of the plurality of engine operational parameters, by the first neural network model, based on the values of adjusting parameters to the engine.

2. The method according to claim 1, wherein providing the second set of values includes:
providing, by the second neural network model, the values of the adjusting parameters to the first neural network model; and
re-training the first neural network model based on the values of the adjusting parameters.

3. The method according to claim 2, further including:
determined the second set of values of the plurality of engine operational parameters based on the re-trained first neural network model; and
providing the second set of values of the plurality of engine operational parameters to the engine.

4. The method according to claim 1, wherein the desired emission level is a desired NOx emission level and the actual emission level is an actual NOx emission level.

5. The method according to claim 4, wherein the actual NOx emission level is provided by a NOx sensor.

6. The method according to claim 5, the method further including:
calculating a difference between the desired NOx emission level, and the actual NOx emission level;
determining whether the difference is within a predetermined range; and
determining a failure of the NOx sensor if the difference is out of the predetermined range.

7. The method according to claim 2, wherein the plurality of engine operational parameters include injection timing and injection pressure of the engine.

8. The method according to claim 2, wherein the first neural network model is an inverse neural network model.

9. The method according to claim 8, wherein the adjusting parameters includes a back-propagation error of the first neural network model and the re-training further includes:
adjusting weights of the first neural network model based on the back-propagation error to minimize the back-propagation error.

10. The method according to claim 1, wherein the providing further includes:
obtaining the values of the plurality of sensing parameters through various physical sensors;
determining the values of the plurality of engine operational parameters based on the first neural network model and the values of the plurality of sensing parameters; and
providing the determined values of the plurality of engine operational parameters to the second neural network model and to the engine.

11. An engine control system for controlling an engine, comprising:
plural physical sensors configured to provide a plurality of sensing parameters; and
a processor configured to:
generate a first neural network model indicative of interrelationships between the plurality of sensing parameters and a plurality of engine operational parameters;
generate a second neural network model indicative of interrelationships between the plurality of engine operational parameters and at least a desired emission level;
provide, via the first neural network model, a first set of values of the plurality of engine operational parameters to the second neural network model and to the engine; and
determine, via the second neural network model, values of adjusting parameters of the first neural network model based on the values of the plurality of engine operational parameters, the desired emission level, and an actual emission level of the engine.

12. The engine control system according to claim 11, wherein the adjusting parameters include a back-propagation error, and the processor is further configured to:
provide, via the second neural network model, the back-propagation error to the first neural network model; and
re-train the first neural network model based on the back-propagation error.

13. The engine control system according to claim 12, wherein the processor is further configured to:
determine a second set of values of the plurality of engine operational parameters based on the re-trained first neural network model; and
provide the second set of values of the plurality of engine operational parameters to the engine.

14. The engine control system according to claim 12, wherein, to re-train the first neural network, the processor is further configured to:
adjust weights of the first neural network model based on the back-propagation error to minimize the back-propagation error.

15. A vehicle, comprising:
an engine which provides power to the vehicle and produces NOx emission at an actual NOx emission level; and
a control system configured to control the engine, the control system including a processor configured to:
generate a first neural network model indicative of interrelationships between a plurality of sensing parameters and a plurality of engine operational parameters;
generate a second neural network model indicative of interrelationships between the plurality of engine operational parameters and at least a desired NOx emission level;
provide, via the first neural network model, a first set of values of the plurality of engine operational parameters to the second neural network model and to the engine; and
determine, via the second neural network model, values of adjusting parameters of the first neural network model based on the values of the plurality of engine operational parameters, the desired NOx emission level, and the actual NOx emission level of the engine.

16. The vehicle according to claim 15, wherein the adjusting parameters include a back-propagation error, and the processor is further configured to:
provide, via the second neural network model, the back-propagation error to the first neural network model; and
re-train the first neural network model based on the back-propagation error.

17. The vehicle according to claim 16, wherein the processor is further configured to:
determine a second set of values of the plurality of engine operational parameters based on the re-trained first neural network model; and
provide the second set of values of the plurality of engine operational parameters to the engine.

18. The vehicle according to claim 16, wherein, to re-train the first neural network, the processor is further configured to:
adjust weights of the first neural network model based on the back-propagation error to minimize the back-propagation error.

19. The vehicle according to claim 16, wherein the processor is further configured to:
calculate a difference between the desired NOx emission level, and the actual NOx emission level;
determine whether the difference is within a predetermined range; and
determine a failure of the NOx sensor if the difference is out of the predetermined range.

20. The vehicle according to claim 16, wherein, to provide the first set of values of the plurality of engine operational parameters, the processor is further configured to:
obtain the values of the plurality of sensing parameters through various physical sensors;
determine the values of the plurality of engine operational parameters based on the first neural network model and the values of the plurality of sensing parameters; and
provide the determined values of the plurality of engine operational parameters to the second neural network model and to the engine.
